(19) United States
(12) Patent Application Publication
(10) Pub. No.: US 2010/0102514 A1
(43) Pub. Date: Apr. 29, 2010

(54) SHAFT SEALING DEVICE

(75) Inventor: Hans-Werner Lipot, Bad Neustadt (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/593,144

(22) PCT Filed: Mar. 26, 2008
(86) PCT No.: PCT/EP08/53575

§ 371 Date: Sep. 25, 2009

(30) Foreign Application Priority Data
Mar. 27, 2007 (DE) 10 2007 014 657.6

(51) Int. Cl. F16J 15/447

(52) U.S. Cl. 277/412

(57) ABSTRACT

The invention relates to a shaft sealing device (11) for sealing gas-fluid mixtures or cooling lubricants in electrical machines of work machines, particularly machine tools, having the following characteristics: —the shaft sealing device (11) is axially positioned between the work machine and the bearing of the electrical machine, —a spin element (6) is connected in a torsion-proof fashion to a shaft (10) of the electrical machine and is designed with at least one rear section (13) facing the bearing, —at least one fixed cover (3) connected to a bearing shield (1) in a fixed manner, the structure of said cover forming a labyrinth seal with the rear section (13) of the spin element (6), —said labyrinth seal comprising at least spray-off edges, two collecting grooves (5, 2), and beveled jacket surfaces, wherein, at least from the last collecting groove (2), via a return channel (4); the delivery of the collected medium to the outside is ensured by the Venturi effect while the electrical machine is in operation.

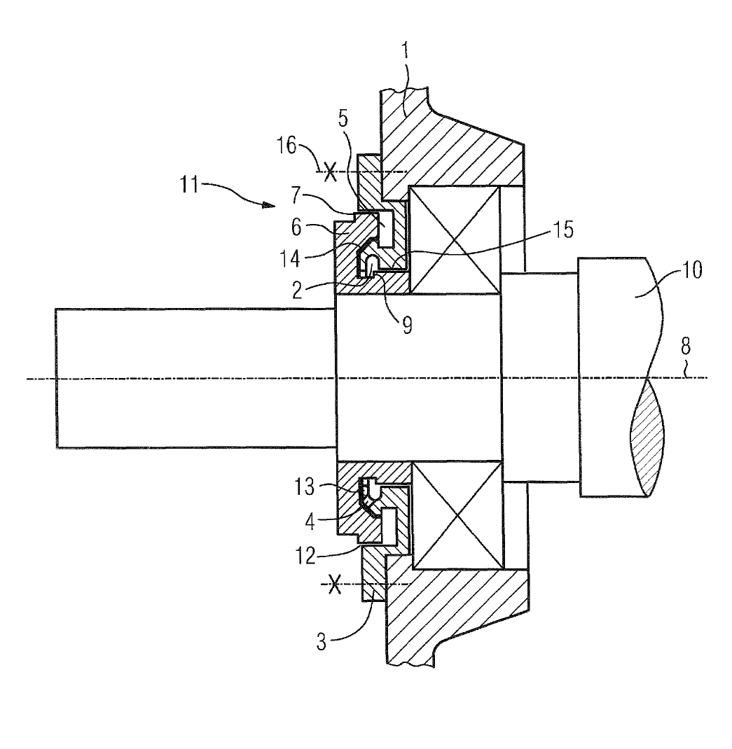

The invention relates to a shaft sealing device for sealing off gas/liquid mixtures or cooling lubricants in electric machines of working machines, in particular machine tools.

Electric machines are usually coupled to working means, for example working machines, in which, depending on their use, cooling lubricant has to be employed in order to control the temperature both of the tool and of the work piece. For example, in modern machine tools, cooling lubricant is introduced under relatively high pressure in the machining space on account of the ever higher machining rotational speeds. These cooling lubricants or gas/liquid mixtures must be kept away from the electric machine, in particular from the bearings and the electric machine itself, that is to say, for example, the electrical windings.

For this reason, labyrinth seals have often been installed hitherto in the construction of machine tools, but because of the multiplicity of individual elements these labyrinth seals are highly complicated in their implementation and are only moderately efficient in their sealing action. Another possibility for achieving sealing is to use shaft sealing rings which, however, cannot ensure sufficient sealing at the rotational speeds required.

DE 43 03 946 C2 discloses an electric machine in which the passage orifice provided for the passage of the shaft on the bearing plate of the machine housing is provided with a sealing device which has a first spin element which is arranged on the outside in front of a first axial passage gap of the leadthrough orifice and is connected fixedly in terms of rotation to the shaft and which engages with its outer margin over an annular collar which is formed on the bearing plate and behind which a run-off channel is formed by a radial indentation, in which machine, furthermore, a second spin element is provided which is arranged, within an annular chamber formed in the passage orifice and provided with an outflow orifice, in front of a second axial passage gap and which is likewise connected fixedly in terms of rotation to the shaft, a gamma ring housing being provided as the first spin element, the second spin element being provided on a bush ring connected to the shaft, and the second passage gap being formed between the outer circumference of the bush ring and a corresponding portion of the bearing plate. The disadvantage of this, inter alia, is the complicated machining of the machine bearing plate.

In DE 39 30 280 C2, a sealing arrangement is constructed from a plurality of individual parts, with dirt tracks, labyrinth seals and radially arranged sealing surfaces, and in this case, on account of the centrifugal force, a suction action is to be established and therefore an outwardly directed flow is to be produced.

The disadvantage, in this case, is that the sealing device has a complicated construction because of the individual parts required, and also a machined shaft is needed in order to ensure that the overall sealing arrangement has a sufficient sealing action.

Proceeding from this, the object on which the invention is based is to provide a shaft sealing device which can be produced at low outlay and which ensures sealing without additional operations to machine the machine elements involved, for example the shaft and bearing rings.

The set object is achieved by means of a shaft sealing device for sealing off gas/liquid mixtures or cooling lubricants in electric machines of working machines, in particular machine tools, which has the following features:
the shaft sealing device is positioned axially between the working machine and the bearing of the electric machine,
a spin element is connected fixedly in terms of rotation to the shaft of the electric machine and is designed with at least one undercut facing the bearing,
at least one stationary cover which is fixedly connected to the bearing plate and of which the design together with the undercut of the spin element forms a labyrinth seal,
this labyrinth seal has at least splash-off edges, two capturing grooves and obliquely running surface areas, the Bernoulli effect ensuring, when the electric machine is in operation, that the medium which has accumulated at least in the last capturing groove is conveyed outward from the latter via a return duct.

The present shaft sealing device according to the invention in this case does not require any additional outlay in terms of machining on the shaft or on the bearing plate in order to position the sealing elements. On the contrary, the necessary components, such as, for example, the spin element and cover, are fastened directly on the shaft or the bearing plate, so that the spin element is simply shrunk onto the shaft and the cover is fastened to the bearing plate by commonly available fastening means, for example screw connections.

Further, the sealing device additionally has, in addition to splash-off edges, sealing gaps and capturing grooves, at least one return duct, by means of which the Venturi effect (Bernoulli's law) causes a medium captured, where appropriate, in the last capturing groove to be conveyed outward from the latter when the electric machine is in operation and under the associated rotational speed of the spin element and the suction action consequently commencing.

As soon as the spin disk is moving at the required rotational speed, a vacuum is generated in the gap due to the flowing medium and immediately discharges outward the medium entering the capturing groove.

Special structural configurations, such as obliquely running surface areas or splash-off edges, increase the sealing action in that they ensure, inter alia, that hardly any gas/liquid mixture or cooling lubricant passes into the capturing grooves of the sealing device, or in that a corresponding suction action is established during operation as a result of an intensification of the Bernoulli effect.

The invention and also further advantageous refinements of the invention may be gathered from the diagrammatically illustrated FIGURE.

A shaft sealing device 11 is arranged between a working machine, not illustrated in any more detail, and an electric machine provided as a drive, in order to keep away the gas/liquid mixtures or cooling lubricants coming from the working machine and harmful to bearings and the electric machine. A shaft 10 in this case has a spin element which is designed as a spin disk 6 and which repels, for example, a splash of cooling lubricant, which impinges onto the shaft sealing device 11, from the sealing gap 12 via this splash-off edge 7 of the spin element. The spin element is in this case designed as a spin disk, but may likewise be designed as a counterbalancing disk, in order thereby at the same time to contribute to the smooth running of the shaft within the drive system. The bearing load is also consequently reduced.

The spin disk has an undercut 13, into which structural elements of a cover 3 engage and thus form, inter alia, a labyrinth seal with sealing gaps. That is to say, any cooling lubricant which has not been repelled by the splash-off edge 7 and penetrates via the sealing gap 12 will normally not be able to pass through there on account of the geometrically small dimensions. Should the cooling lubricant nevertheless pass through this sealing gap, it enters a capturing groove 5 which is formed in the cover 3 and which is delimited, inter alia, by the spin disk 6. A further sealing gap 14 leads from this capturing groove 5 via a plurality of axial, oblique and radial deflections into a capturing groove 2 into which, in turn, a splash-off edge 9 of the spin disk 6 projects, in order to repel from the remaining sealing gap 15, which ultimately leads to the bearing, the remaining residual quantities of the cooling lubricant. The cover 3 is in this case fastened to the bearing plate 1 in a defined manner by fastening means known per se, for example a screw 16 or a snap mechanism, so that the required gaps and the suction action associated with these are established by virtue of the Venturi effect.

On account of the return duct 4, which in this case points from the capturing groove 2 to the sealing gap 14, and of the vacuum established in the gap 14 when, for example, a rotating electric machine is in operation, gas/liquid mixture entering the capturing groove 2 is routed outward via this return duct 4 and the sealing gap 14. The gas/liquid mixture may also be another flowing medium, such as, for example, a cooling lubricant.

An efficient and simple shaft sealing device 11 is consequently provided, without the machine elements involved in it, such as the bearing plate 1 and shaft 10, having to be additionally machined. Furthermore, the sealing action rises, the higher the rotational speed of the electric machine is and, consequently, the higher the suction action established by virtue of the Venturi effect is.

Even in the case of a higher coolant pressure, the penetration of cooling lubricants or of other gas/liquid mixtures into the bearings or the electric machine is consequently avoided, and therefore operating failures due to damaged bearings or to defective electric machines can be ruled out.

The surface areas of the spin element 6 and/or the cover 3 are preferably arranged such that the Venturi effect can arise in a simple way. These surface areas are therefore designed obliquely or radially with respect to the shaft axis 8.

The shaft sealing device 11 according to the invention can not only be used in machine tools, but, for example, also in traction drives, for example locomotives, streetcars, mining trucks.

1.-5. (canceled)

6. A shaft sealing device positioned axially between a working machine and a bearing of an electric machine for sealing off a medium, said sealing device comprising:
a spin element connected in fixed rotative engagement with a shaft of the electric machine and provided with at least one undercut facing the bearing of the electric machine; and
at least one stationary cover which is fixedly connected to a bearing plate and configured to jointly form with the undercut of the spin element a labyrinth seal,
wherein the labyrinth seal has a first capturing groove to accumulate medium migrating via a first sealing gap and to convey the medium outward via a return duct as a result of a Venturi effect, when the electric machine is in operation.

7. The shaft sealing device of claim 6, wherein the working machine is a machine tool.

8. The shaft sealing device of claim 6, wherein the medium is a gas/liquid mixture or a cooling lubricant.

9. The shaft sealing device of claim 6, wherein the labyrinth seal has a second capturing groove for accumulating migrating medium via a second sealing gap, said further capturing groove being bounded by the cover and the spin element and in fluid communication with the first capturing groove.

10. The shaft sealing device of claim 6, wherein the spin element has at least two splash-off edges to provide a medium barrier.

11. The shaft sealing device of claim 10, wherein one of the splash-off edges is arranged in a region of the first capturing groove.

12. The shaft sealing device of claim 9, wherein at least one of the spin element and the cover has in the region of the first and second sealing gaps surface areas which are designed to establish a conveying action.

13. The shaft sealing device of claim 12, wherein the surface areas extend obliquely or radially with respect to an axis of the shaft.
